(19) United States
(12) Patent Application Publication
(10) Pub. No.: US 2026/0241660 A1
(43) Pub. Date: Aug. 20, 2026

(54) Modular Mat System

(71) Applicant: Spartan Matt LLC, Rockledge, FL (US)

(72) Inventors: Caleb Delp, Rockledge, FL (US); Aaron Allen, Orlando, FL (US); Justin Thelin, Gilbert, AZ (US); Brian Schenk, Rockledge, FL (US)

(21) Appl. No.: 19/639,844

(22) Filed: Apr. 6, 2026

Related U.S. Application Data
(63) Continuation-in-part of application No. 17/761,511, filed on Mar. 17, 2022, now Pat. No. 12,618,201.

(51) Int. Cl. B32B 3/30; B32B 27/32; B32B 37/16

(52) U.S. Cl. CPC B32B 3/30; B32B 27/32; B32B 37/16; B32B 2305/02; B32B 2305/08; B32B 2307/54; B32B 2307/7376

(57) ABSTRACT

A modular mat system comprises a mat panel having a base portion and an overlay portion joined by a continuous fusion weld extending across a sloped transition surface connecting a first wall rib to a zero-degree horizontal flange surface, without termination at the first wall rib. The zero-degree flange surface maximizes weld cross-section and shear strength of the first wall rib under deflection loading. A second wall rib disposed on the flange outboard of the first wall rib extends through the full flange thickness along the full length of the flange-to-first-wall-rib intersection, with locally increased skin thickness, distributing stress away from the first wall rib into the flange. The central core section has a zonally optimized cellular structure with progressively increasing rib density toward the first wall rib. The bottom skin includes vacuum-sealable pad regions for robotic handling. Adjacent panels connect by overlapping extension portions secured with connecting pins.

### CROSS REFERENCE TO RELATED APPLICATIONS

This application is a continuation-in-part of U.S. Patent App No. 17/761,511 filed March. 17, 2022, which claims the benefit of PCT Application No. PCT/US20/57250 having a filing date of October 24, 2020, each of which is incorporated by reference in its entirety, including all appendices, as if fully set forth herein.

### TECHNICAL FIELD

The present specification relates to a modular mat system, more particularly a modular mat system with uniform construction with an enforced flange which provides increased strength, protection and durability for heavy industrial environments.

### BACKGROUND

Heavy duty modular mat systems have been designed and utilized to provide temporary and rigid driving surfaces in remote and inaccessible areas. Such modular mat systems are primarily used where the natural environment provides unstable and soft surfaces for heavy construction equipment to drive across and operate. Heavy duty modular mat systems may be utilized to provide driveways, parking areas, walkways, platforms, or others rigid surfaces for vehicles, or other equipment. The modular mats can be adapted to the particular topographic or geographic needs of the particular work site.

In operation, the choice of a mat system is primarily based upon the amount of load expected to be exerted on the mat, and the condition of the environment that the mat will be placed on which can be rock, dirt, concrete, grass, mud, water, mud, rock, or other such underlying substrates. Heavier construction equipment requires that the mats be resistant to cracking and breaking while under load, which can result in mats that are heavy and more cumbersome for the user. Since most construction sites are in undeveloped or remote areas, installation and removal of the mats are very expensive and time consuming. Because of the high costs associated with installation and removal of a modular mat the process must be done quickly and efficiently.

Traditional mats generally use modular mat tiles that are linked together by a plurality of connectors which can be some mechanical mechanism. The mechanical mechanisms can be bolts or multiple piece cams that lock the mats together. Complex interactions between the mats causes stress between the mats and the connection points. In addition, this type of method requires the use of a large number of mats with bolts or multiple piece cams that lock the mats together in a side-by-side fashion, which can be tedious and time consuming when dealing with large areas. These mats are connected at one or more flanges that extend beyond the main body of the mat. These flanges are either part of the top main body, bottom main body, or both wherein the flanges are usually a solid piece which can decrease the structural strength when attached to the opposing mat when bending or flexing while under load.

Current mats such as that provided in U.S. Pat. No. 9,506,255 provides for a modular mat having two layers wherein the layers have a central portion and flange that extends outwardly from the central portion. The two layers have at least one fitting receiver and a locking pin that connects the mats together. This type of mat design is limited in structural strength because it adds stress risers to the points within the central portion of the mat where the fitting receivers are located, and where the mats are connected together by a mechanical mechanism. These stress risers prohibited the mat to freely extend or flex when a heavy vehicle is driving across or stored on the mat. At the points where the stress risers are located these types of mats become brittle and crack under load and will eventually lose structural integrity. In addition, this mat design comprises apertures that extend through the first flange and the second flange wherein the apertures can have as much as quarter inch difference in size between the plurality of apertures causing for loose fitting receivers. Further, this type of mat design allows for severe warpage during the manufacturing process and during the welding of the two mat halves of the mat.

It would be advantageous to provide a modular mat system which maintains it structural integrity under high loads and is durable for heavy industrial applications. There is also a need for a modular mat system that can quickly be assembled and disassembled.

### SUMMARY OF THE INVENTION

The present invention provides among other things a modular mat system comprising a mat panel and an overlay portion joined by a continuous fusion weld that extends across all transitions in the mat, including across a sloped transition surface connecting a reinforced first wall rib to a zero-degree horizontal flange surface. In some embodiments, no unwelded interface exists at any structural transition. The system may include a second wall rib disposed on the flange outboard of the first wall rib, running the full length of the flange-to-first-wall-rib intersection through the full flange thickness, with locally increased skin thickness in the region of the second wall rib to distribute stress away from the first wall rib and into the flange.

It is an object of the present invention to provide a continuous fusion weld across all structural transitions in a modular mat panel, including across the deck-to-flange transition.

It is another object of the present invention to prevent fracture initiation in the central core section of a modular mat panel under heavy industrial loading.

It is another object of the present invention to direct structural failure to the flange of a modular mat panel rather than to the central core section.

It is another object of the present invention to maximize the shear strength of the vertical flange wall by forming the fusion weld on a zero-degree horizontal flange surface.

It is another object of the present invention to distribute stress away from the vertical flange wall and into the flange body by means of a second wall rib and locally increased skin thickness outboard of the first wall rib.

It is another object of the present invention to enable robotic lifting of a modular mat panel by providing vacuum-sealable pad regions on the bottom skin.

It is another object of the present invention to provide a modular mat surface that can be rapidly assembled and disassembled in heavy industrial field environments.

The above and other objects may be achieved using a modular mat system comprising a mat panel having a base portion and an overlay portion. The base portion has a top and a first thickness. The overlay portion has a second thickness and a central core section extending from the top of the base portion. The base portion extends past the overlay portion on a first side and a first end to form a base side extension portion and a base end extension portion. The overlay portion extends past the base portion on a second side and a second end to form an overlay side extension portion and an overlay end extension portion. The base side extension portion, base end extension portion, overlay side extension portion, and overlay end extension portion collectively form a flange surrounding the central core section. The flange has a top surface, a bottom surface, and a flange thickness. The base side extension portion may be configured to fit beneath the overlay side extension portion of a first adjacent mat panel, and the base end extension portion may be configured to fit beneath the overlay end extension portion of a second adjacent mat panel.

A first wall rib having a cross-sectional thickness greater than the rib thickness of the interior cellular structure of the central core section has an interior surface that substantially surrounds and defines the perimeter of the central core section and an exterior surface that faces the flange. A sloped transition surface connects the exterior surface of the first wall rib to the top surface of the flange.

The base portion and the overlay portion may be fusion welded continuously across the sloped transition surface from the central core section into the flange without termination at the first wall rib. The top surface of the flange may be oriented at zero degrees relative to the horizontal plane of the mat panel, and the fusion weld at the flange may be formed on the zero-degree top surface. A second wall rib may be disposed on the flange outboard of the first wall rib, extending between the top surface and the bottom surface of the flange along the full length of the intersection of the flange with the first wall rib. The flange may have a locally increased skin thickness in the region of the second wall rib. The bottom skin may comprise a plurality of vacuum-sealable pad regions configured to form an airtight seal with vacuum lifting cups of a robotic handling system.

The above and other objects may also be achieved using a method of assembling a modular mat surface comprising providing a plurality of mat panels each having a continuous fusion weld across the sloped transition surface and a second wall rib on the flange; positioning adjacent mat panels so that base extension portions fit beneath overlay extension portions; aligning guide holes in the extension portions; and inserting connecting pins through the aligned guide holes. The method may further comprise lifting mat panels using vacuum lifting cups applied to vacuum-sealable pad regions on the bottom skin, and may further comprise extending the mat surface in multiple directions by connecting additional mat panels along both the side and end extension portions.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the. Absent such clear statements of intent to apply a “special” definition, it is the inventor’s intent and desire that the simple, plain, and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112 (f). Thus, the use of the words “function,” “means” or “step” in the Detailed Description or Description of the Drawings or claims is not intended to somehow indicate a desire to invoke the special provisions of 35 U.S.C. § 112 (f), to define the invention. To the contrary, if the provisions of 35 U.S.C. § 112 (f) are sought to be invoked to define the inventions, the claims will specifically and expressly state the exact phrases “means for” or “step for”, and will also recite the word “function” (i.e., will state “means for performing the function of creating a modulate mat, without also reciting in such phrases any structure, material or act in support of the function. Thus, even when the claims recite a “means for performing the function of molding a modulate mat, step for performing the function of molding a modular mat,” if the claims also recite any structure, material or acts in support of that means or step, or that perform the recited function, then it is the clear intention of the inventors not to invoke the provisions of 35 U.S.C. § 112 (f). Moreover, even if the provisions of 35 U.S.C. § 112 (f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

Additional features and advantages of the present specification will become apparent to those skilled in the art upon consideration of the following detailed description of the illustrative embodiment exemplifying the best mode of carrying out the invention as presently perceived.

### BRIEF DESCRIPTION OF THE DRAWINGS

These and other features, aspects, and advantages of the present specification will become better understood regarding the following description, appended claims, and accompanying drawings where:

FIG. 1 is an isometric view of a modular mat in accordance to one, or more embodiments;

FIG. 2a is an exploded top isometric view of a modular mat in accordance to one, or more embodiments;

FIG. 2b is an exploded bottom isometric view of a modular mat in accordance to one, or more embodiments;

FIG. 2c is an exploded bottom isometric view of the preferred embodiment of a modular mat in accordance to one, or more embodiments;

FIG. 3a is an isometric exploded view, with the first layer omitted, of a modular mat in accordance to one, or more embodiments;

FIG. 3b is an isometric exploded view, with the first layer omitted, of a modular mat in accordance a different embodiment than that shown in FIG. 3a.

FIG. 4 is a top view of a modular mat in accordance to one, or more embodiments;

FIG. 5a is a top view of an interior surface, with the first layer being omitted, of a modular mat in accordance to one, or more embodiments;

FIG. 5b is a top view of an interior surface, with the first layer being omitted, of a modular mat in accordance to one, or more embodiments;

FIG. 6 is a cross-sectional view of a modular mat in accordance to one, or more embodiments;

FIG. 7 is an isometric view of a modular mat system in accordance to one, or more embodiments;

FIG. 8 is a cross-sectional view of a modular mat system in accordance to one, or more embodiments;

FIG. 9 is an exploded, side view showing the connection point of a modular mat system in accordance to one, or more embodiments;

FIG. 10 is an isometric overhead view of another embodiment of a modular mat system in accordance to one, or more embodiments;

FIG. 11a is a top view of another embodiment of a modular mat system in accordance to one, or more embodiments;

FIG. 11b is a cross-sectional view of FIG. 11a omitting one side of another embodiment of a modular mat system in accordance to one, or more embodiments;

FIG. 11c is a close-up view of FIG. 11b omitting one side of another embodiment of a modular mat system in accordance to one, or more embodiments;

FIG. 12 is a side view of another embodiment of a modular mat system in accordance to one, or more embodiments;

FIG. 13 is a bottom view of another embodiment of a modular mat system in accordance to one, or more embodiments; and

FIG. 14 is a top view with one side omitted of another embodiment of a modular mat system in accordance to one, or more embodiments.

FIG. 15 is a cut away view of rib cross-sections showing a stringer pattern relative to a hexagonal pattern in accordance to one, or more embodiments.

### DETAILED DESCRIPTION

In the following description, and for the purposes of explanation, numerous specific details are set forth to provide a thorough understanding of the various aspects of the invention. It will be understood, however, by those skilled in the relevant arts, that the present invention may be practiced without these specific details. In other instances, known structures and devices are shown or discussed more generally to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed inventions may be applied. The full scope of the inventions is not limited to the examples that are described below.

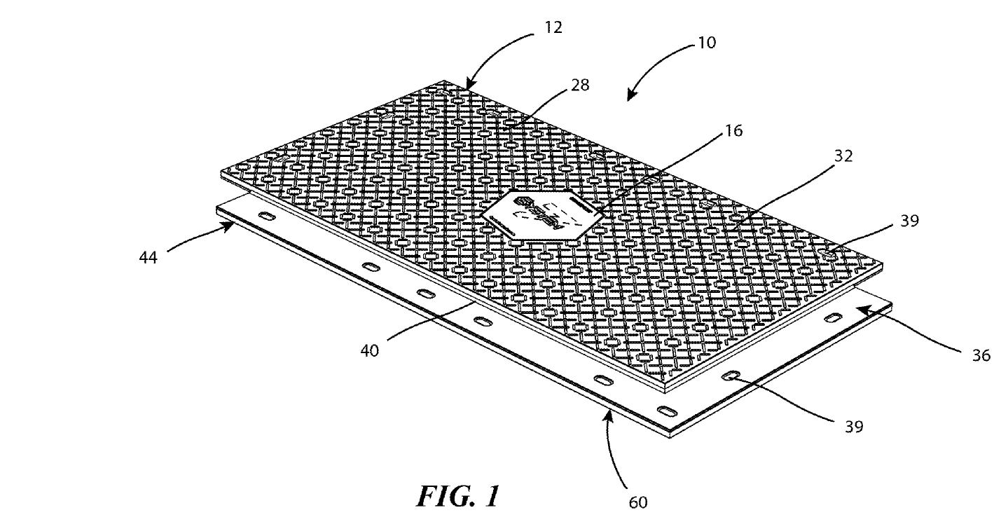

As shown in the accompanying figures, a modular mat system 100 can comprise a plurality of modular mat system 10. Referring initially to FIG. 1 - 6, the modular mat system 10 can comprise at least two halves, a first layer 12 is joined to a second layer 60 form the modular mat system. The first layer 12 and the second layer 60 can produce a dual surface, having the same or varying surface patterns to support heavy weight, and industrial applications and vehicles wherein the vehicles can need some type of support to drive over such as, dirt, gravel, water, sand, mud, or the like. The first layer 12 and the second layer 60 can be joined or affixed together, as described further herein, and can produce no offset layers or portions. The modular mat system 10 can be any suitable dimension that creates a ground covering that can support high industrial vehicles such as, but not limited to, tractors, cranes, trucks, or the like. The modular mat 10 length can be for example between 10.5 feet to 15 feet, more preferably between 11 feet and 13.5 feet, and still more preferably a length of approximately 12.75 feet. The modular mat 10 width can be for example between 4 feet to 7.25 feet, more preferably between 5 feet and 7 feet, and still more preferably a length of approximately 6.5 feet. The modular mat system 10 thickness can be for example between .25 inches to 18 inches, more preferably between 3 feet and 14 inches, and still more preferably a length of approximately 4.35 inches but can be any suitable dimension that allows for heavy, industrial equipment to drive over the modular mt system 10.

The first layer 12 and second layer 60 can each have an exterior surface and an interior surface wherein an interior surface 18 can comprise a central core 16. The modular mat system 10 can be constructed of any suitable material that withstand high loads from industrial equipment such as, for example, high-density polyethylene (HDPE), polystyrene, polypropylene, acrylonitrile butadiene styrene, polyvinylchloride, or the like. In a preferred embodiment, the material is able to bend, flex, compress, and resist impacts without cracking or breaking. The material can also be resistant to a range of temperatures, UV resistant, and can be injected with other types of material during the manufacturing process for added strength. However, it should be understood that the modular mat system 10 can be constructed of any suitable material having the strength and durability requirements necessary for its intended purpose. The central core 16 can comprise the majority of the modular mat system 10 and provides the usable surface which heavy equipment may travel across. The central core 16 can be substantially planar, to allow for heavy loads to easily drive across, or rest upon. The central core 16 is substantially rectangular in shape, but can be for example, square, circular, hexagonal, or the like provided that the modular mat system can be easily overlapped and locked together with adjacent modular mat systems 10.

The first layer 12 and second layer 60 can comprise an interior surface 18 and an exterior surface 28 wherein the interior surface can comprise a first cellular structure 20 formed from ribs 22 extending from the interior surface wherein the cells of the first cellular structure can have a first cross section. The ribs 22 can be integrally formed or disposed on the central core 16 wherein the ribs can create a series of intersecting reinforcing supports creating a plurality of spaces within the interior surface 18. The ribs 22 can be disposed on the interior surface 18 creating the first cellular structure 20 wherein the first cellular structure can be any suitable configuration, such as square, rectangular, honeycomb, triangular, honeycomb, or any combination thereof. The first cellular structure 20 can be fully integrated within the interior surface 18 of the central core 16, or in other embodiments the first cellular structure can be integrated on a portion of the central core wherein a portion of the central core can be a solid mat and the other portion can comprise a first cellular structure. The ribs 22 can be such as, for example, form-rib, plate-type ribs, truss ribs, closed ribs, forged ribs, milled ribs, or the like to add strength and support to the central core 16, interior surface 18 and the exterior surface 28. The interior surface 18 and the central core 16 can create a thickness wherein the thickness can be between .25 inches to 18 inches, more preferably between 3 feet and 14 inches, and still more preferably a length of approximately 4.35 inches but can be any suitable dimension that allows for heavy, industrial equipment.

The exterior surface 28 can comprise a plurality of traction elements 32 disposed in a pattern which can increase the friction between the surface of the modular mat system 10 and the tires or tracks of a heavy industrial vehicle. The traction elements 32 generally extend outwardly from the exterior surface 28. The traction elements 32 are can be substantially between and do not align with the ribs 22 or can be aligned with the ribs on the interior surface 18 wherein aligning the traction elements with the ribs can increase the strength and distribute the weight of the vehicle from the traction elements to the ribs. The traction elements 32 can be a plurality of different shapes such as, rectangular, circular, square, hexagonal, or the like and can be in varying patterns which repeat across the whole or partial across the exterior surface 28. The traction elements 32 can extend outwardly from the exterior surface 28 at a length of which can be for example, between .05 inches to 3 inches, more preferably between .1 feet and 1.5 inches, and still more preferably a length of approximately .125 inches. In other embodiments the traction elements 32 can be recessed into the exterior surface 28, or can be set outwardly at an angle, or any combination thereof. The first layer 12 and the second layer 60 can have the same or similar central core 16 and interior surface 18 wherein the first cellular structure 20 of the first layer 12 can mate with the first cellular structure of the second layer. The first layer 12 and the second layer’s 60 exterior surface 28 can have the same traction elements 32 or can have varying traction elements on each of the outer surfaces.

A first band 44 can extend from at least one side of the central core 16, wherein the first band has a second cellular structure 46 formed from ribs 45 extending from the interior surface 18 of the first band, wherein the cells of the second cellular structure 46 can have a second cross section wherein the second cross section is substantially smaller than the first cross section. The first cellular structure 20 can be larger or smaller in height, thickness and cell density than the second cellular structure 46. The first band 44 has a first portion 48 that is proximal to the central core 16 and a second portion 50 that can be distal to the central core, wherein the second portion has a third cellular structure 52 formed from ribs 54 extending from the interior surface 18 of the first band, wherein the third cellular structure has a third cross section and the cross section of the third cellular structure is substantially smaller than the cross section of the second cellular structure 46. In certain embodiments the cross section of the third cellular structure 52 can be larger than the cross section of the second cellular structure 46 wherein the thickness, height and cell density can be larger or smaller than the second cellular structure.

In embodiment the first band 44 can include at least one guide hole 39 in the first band. A guide hole can be in the first portion 48 of the first band 44. The guide holes 39 can be recessed into the exterior surface of the flange and can generally be rectangular in shape with radius ends, however, it may be any suitable shape, including square, triangular, or hexagonal. The guide holes 39 can be equal distance apart or placed such that the guides are positioned at varying distances. The guide holes 39 can be holes or can be solid piece of material wherein the holes can be machined into the guide holes after the mat is formed by such as, for example an end mill, drill, router or the like. In certain embodiments, the guide holes 39 can be omitted from the flange.

The modular mat system 10 can further comprise at least one second band 36 wherein a second band can be attached to the central core 16, both the first layer 12 and the second layer 60 can have a second band, wherein the second band can extend peripherally from at least one side of the central core 16, wherein the second band is vertically offset from a first band 44. The second band 36 has a fourth cellular structure 37 formed from ribs 38 extending from the interior surface of the second band. The second band 36 can connect to the central core 16 at a peripheral wall 34, and wherein the peripheral wall can be taller than the cell ribs that contact the peripheral wall from the first cellular structure 20. In other embodiments, the peripheral wall 34 can be shorter than the cell ribs that contact the peripheral wall from the first cellular structure.

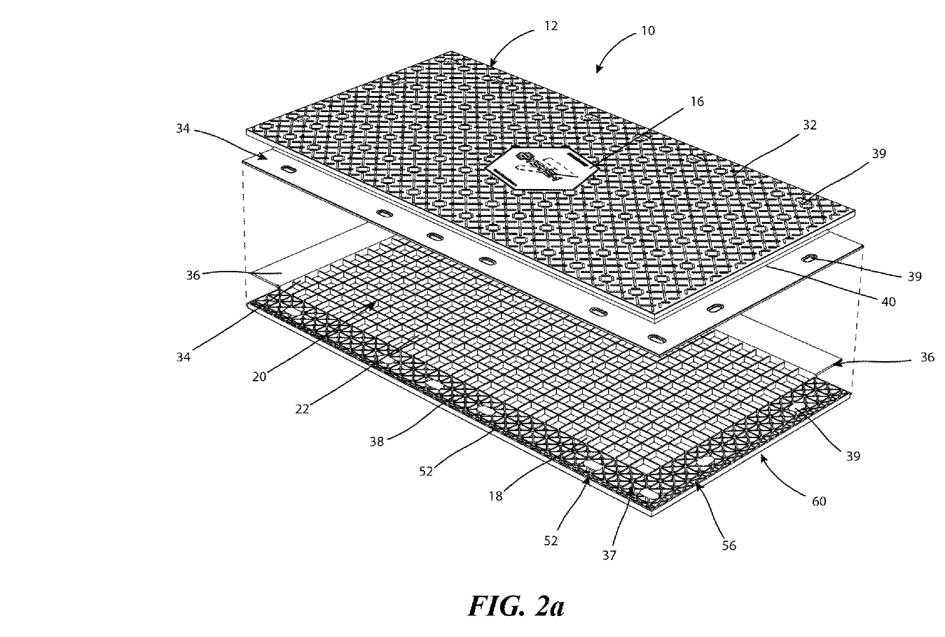

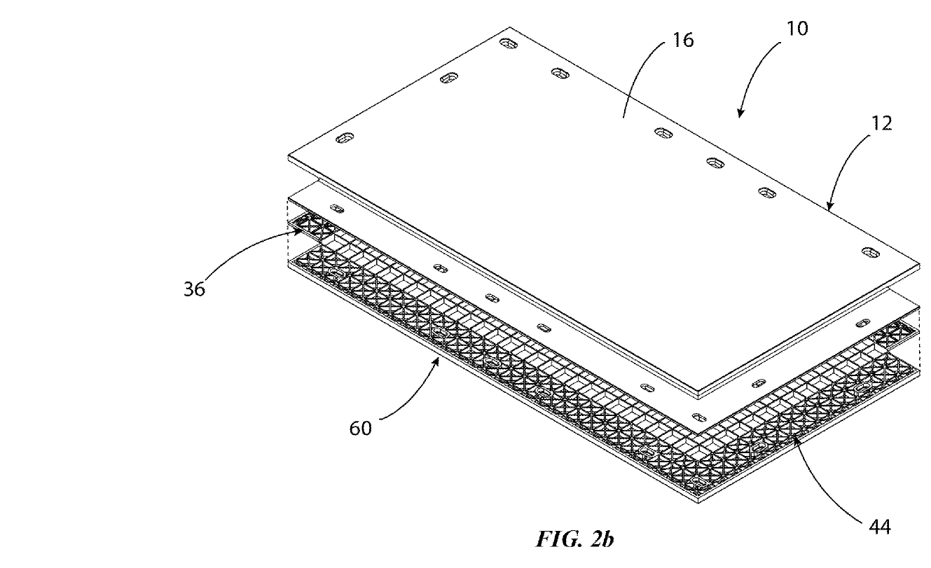

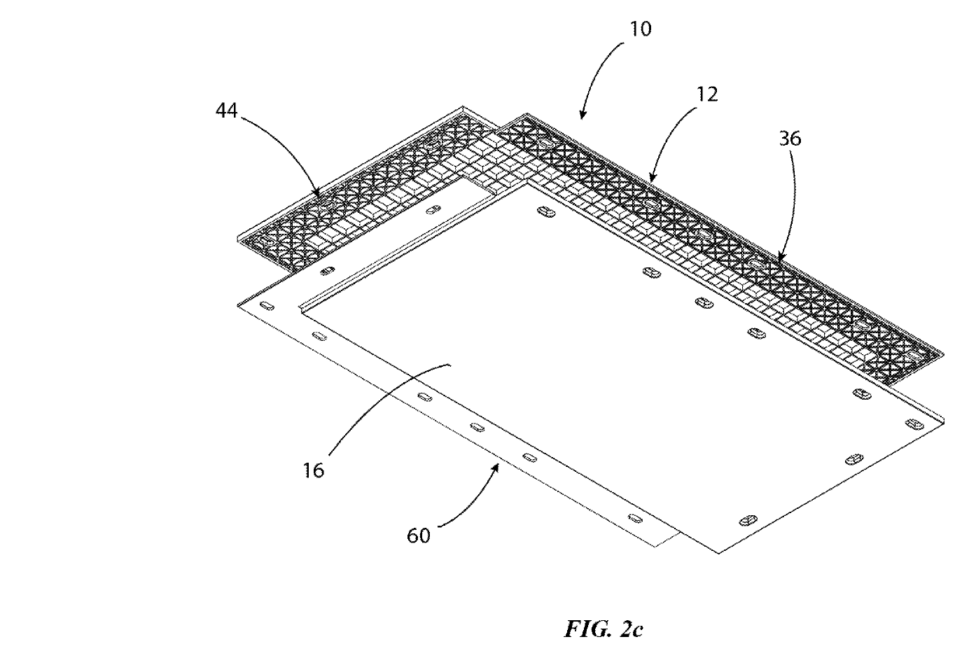

The second band 36 can be offset vertically from the interior surface 18 and the central core 16 and can extend outwardly from the central core 16. The second band 36 can comprise one or more fourth cellular structures 37 which can connect to a secondary perimeter 58 having a thickness or in other embodiments the second band can be flat as shown in FIG. 2a. In other embodiments, the fourth cellular structure 37 can have a higher density rib 38 structure than the first cellular structure 20 or the second cellular structure 46. The cell ribs of the first band 44 and the second band 36 can have a height, and wherein the height of the cell ribs of the second band can be substantially lower than the height of the cell ribs of the first band. In other embodiments, the cell ribs of the first band can have a height that is substantially higher than the height of the cell ribs of the first band. The first layer 12 and the second layer 60 are fusion welded together wherein the cell ribs of the first layer are welded to the cell ribs of the second layer. The first band 44 of the first layer 12 is fusion welded to the second band 36 of the second layer 60.

The second band 36 has a first portion that is proximal to the central core and a second portion distal to the central core, wherein the second portion has a fifth cellular structure 56 formed from ribs extending from the interior surface of the second band, wherein cross section of the cellular structure of the second portion of the second band is substantially smaller than the cross section of the first portion of the second band. The fifth cellular structure 56 can have a substantially smaller density of cells than the fourth cellular structure 37 wherein the fifth cellular structure can have a solid portion on its outer most perimeter portion. In other embodiments the fifth cellular structure 56 can have a substantially larger density of cells than the fourth cellular structure 37.

In embodiments, the cross sections of the cellular structure of the first band 44 and the cellular structure of the second band 36 are the same and in other embodiment the cross-sectional area can vary in thickness, height, and density.

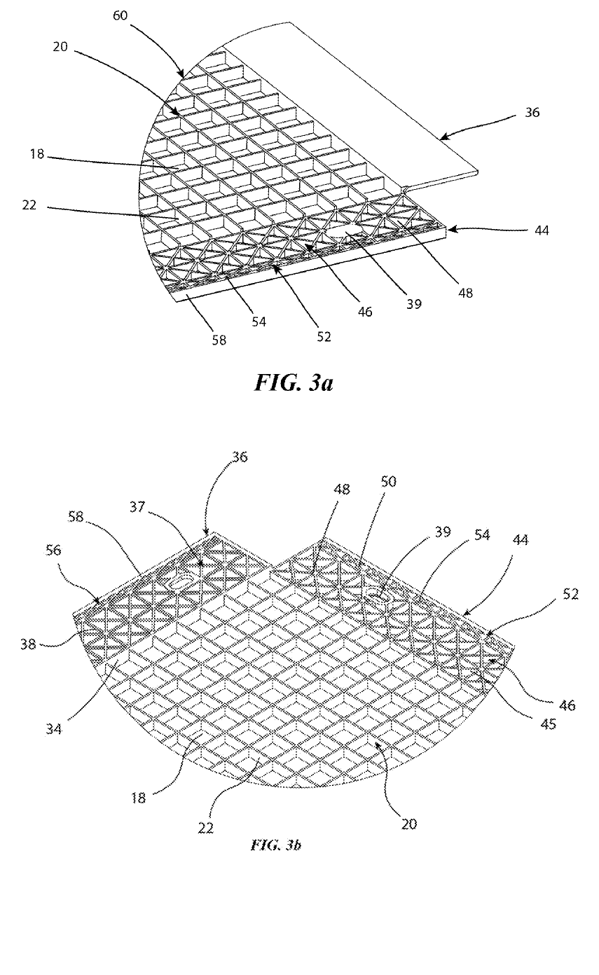

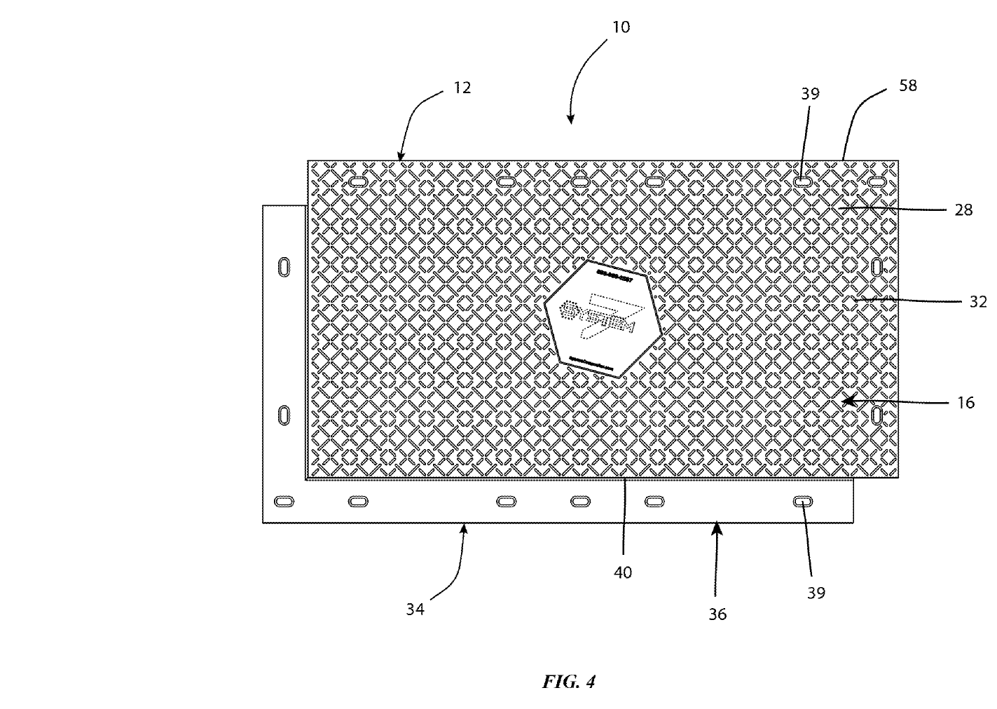

The fourth cellular structure 37 and fifth cellular structure 56 can allow for the material to melt into the cells when the first layer 12 and second layer 60 are welded together as described herein creating a stronger more solid flange. The second band 36 can be integrally formed, or formed separately from, and then affixed to the central core 16. In the preferred embodiment the second band 36 is integrally formed as a part of the central core 16. The first band 44, second band 36 and the central core 16 can be formed from the same material, such as, high-density polyethylene (HDPE), polystyrene, polypropylene, acrylonitrile butadiene styrene, polyvinylchloride, or the like. The first band 44 and the second band 36 can be disposed along at least one edge of the central core 16 wherein the second band can be offset vertically from the central core by for example, between .125 and 4 inches, more preferably between .2 inches and 2 inches and still more preferably a vertical offset of at least 1 inch as shown in FIG. 3. The first band 44 can have the same exterior surface 28 as the central core 16.

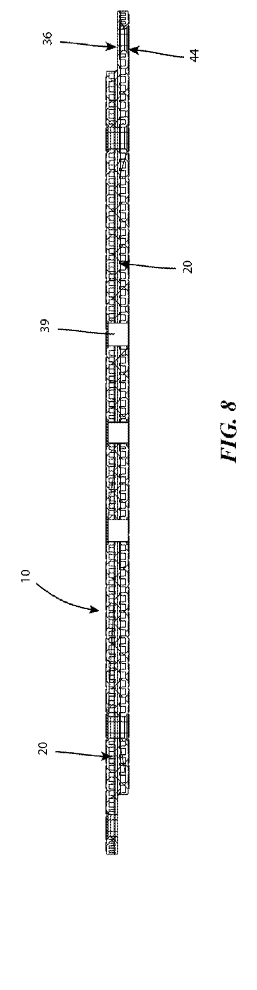

The second band 36 can be configured and positioned to provide an area for an adjacent modular mat 10 to overlap and join to the first modular mat as shown in FIG. 8 by the first band 44 wherein the first band guide holes 39 can substantially align with the guide holes of the second band. In other embodiments the second band 36 can be a solid piece of material and can substantially extend from the central core 16 at a constant thickness from its attachment point as shown in FIG. 2a. The second band can have a transition 40 to the central core 16 and exterior surface 28 wherein the transition can be, such as, a radius, a chamfer, a fillet, or the like. The transition 40 can be machined, welded, molded, or the like into the second band 36 and the central core 16, which adds strength and durability to the modular mat system 10 when in flexion or compression. In other embodiments, the second band 36 can extend along a substantial length of at least one side of the central core 16, it can extend along the length of every side of the central core or it can extend partially along the length of the central core. The second band 36 can comprise at least one guide hole 39 wherein the guide hole can be recessed into the exterior surface 28 of the second band and the first band 44 and can generally be rectangular in shape with radius ends, however, it may be any suitable shape, including square, triangular, or hexagonal. The guide holes 39 can be equal distance apart or placed such that the guides are positioned at varying distances. In certain embodiments, the guide holes 39 can be omitted from the first band 44 and the second band 36. The second layer 60, similarly has a second band 36 and a first band 44 with all its associated features.

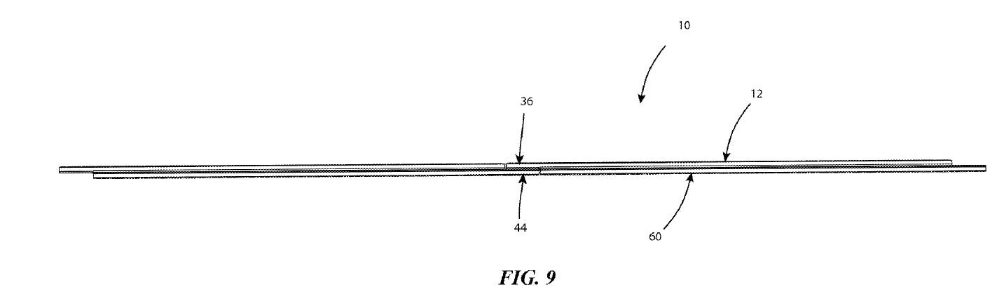

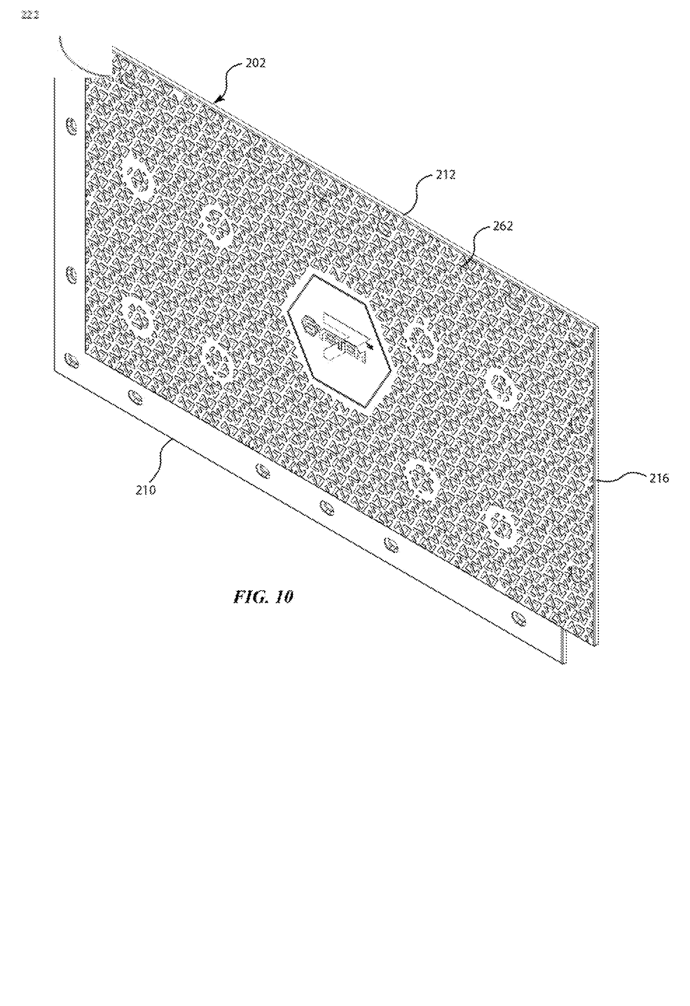

In embodiments, the second band 36 can comprise a fourth cellular structure 37 and a fifth cellular structure 56 wherein the fourth cellular structure and fifth cellular structure can have similar properties to the second cellular structure 46 and third cellular structure 52 wherein the fourth cellular structure can be a finer mesh than the first cellular structure and the fifth cellular structure can be an even finer mesh than the fourth cellular structure, which adds strength to second band and the first band in both flexion and bending, and it can prevent possible pin tear out when the modular mat systems 10 are connected together with a pin (See FIG. 9). In addition, the finer cellular structure add strength to the first band and the second band allowing for larger vehicles to drive over the bands without deforming or warping the first band and the second band. The second band 36 and first band 44 are formed from the same material as the central core 16 such as, for example, high-density polyethylene (HDPE) plastic, polystyrene, polypropylene, acrylonitrile butadiene styrene, polyvinylchloride, or the like. The first cellular structure 20, secondary cellular structure 46, third cellular structure 52, fourth cellular structure 37 and the fifth cellular structure 56 can have a shape of a for example, but not limited to, triangle, square, rectangular, hexagonal, or the like.

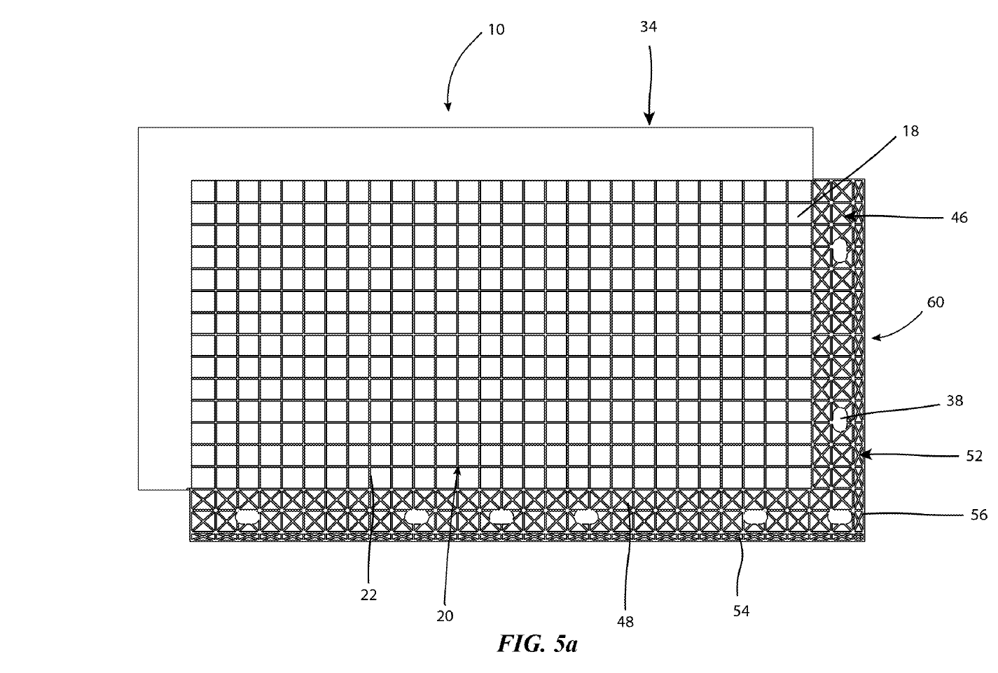

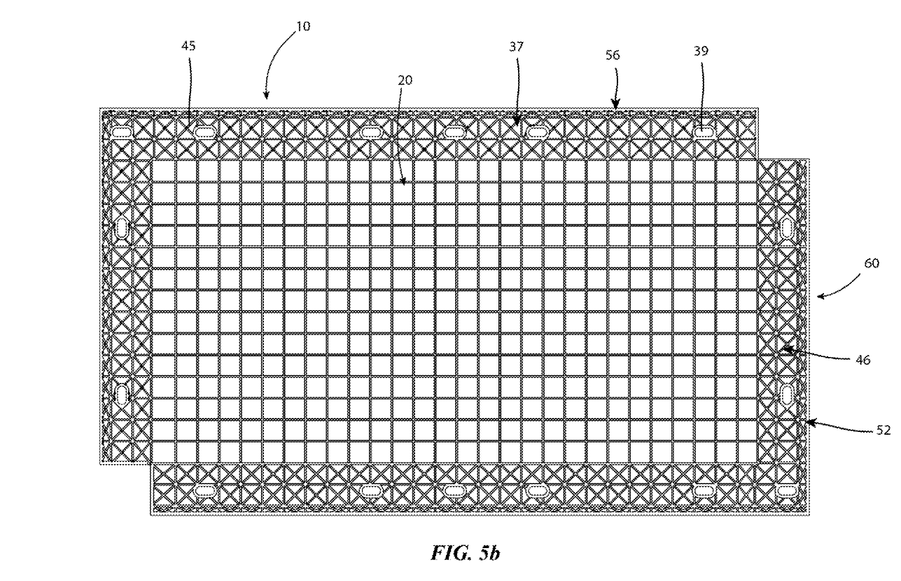

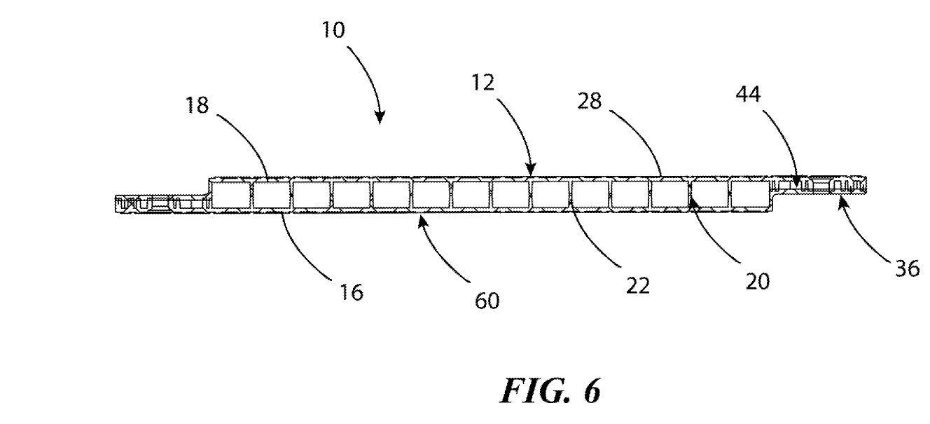

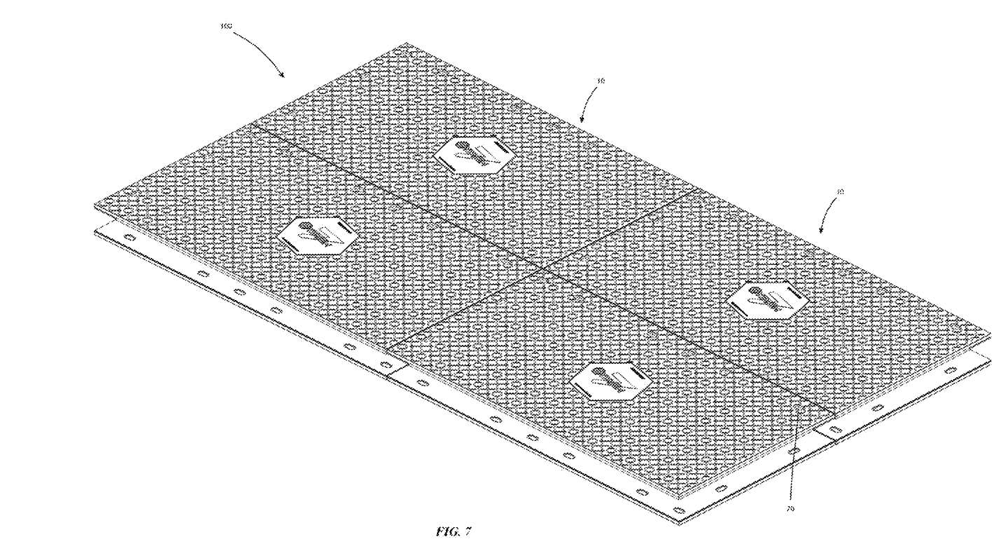

A perimeter 58 can surround the outer most portion of the third cellular structure 52 and the fifth cellular structure 56. The perimeter 58 can encompass the first band 44 and the second band 36. The perimeter 58 as show in FIG. 4b can be congruent throughout its entirety, such that there are no overhangs or offset portions of the modular mat system 10 in which the first layer 12 and the second layer 60 are not matched or can be matched to the corresponding sections of the opposite layer.

The first layer 12 and the second layer 60 can be joined together to form one complete module mat system 10 by affixing the interior surfaces 18 together, including, but not limited to, fusion welding, hot welding or hand welding, seam welding and other methods appropriate for the materials comprising the first layer 12 and the second layer 60. Further, multiple methods of affixing the first layer 12 and the second layer 60 together can be utilized simultaneously such as, for example, the inner portions can be fusion welded and can be seamed welded together creating a seal around the modular mat system. The first layer 12 and the second layer 60 can be welded together wherein at least a portion of the cellular structures can be welded, but more preferably the entire inner portion of the cellular structures are welded together such that the first layer 12 and the second layer 60 can become one piece.

During the welding process the first layer 12 and the second layer 60 can be heated to a temperature sufficient to soften, but not melt, the material and the first layer and the second layer can be compressed together having each side overlap by for example, between .032 and 4 inches, more preferably between .1 inches and 2 inches and still more preferably a vertical offset of at least .125 inch. The first layer 12 and the second layer 60 can overlap by for example, between .032 and 4 inches, more preferably between .1 inches and 2 inches and still more preferably a vertical offset of at least .25 inch when compressed together. Any material extruded at the seam of the joined surfaces resulting from compression may be removed, such as by grinding, milling, routing, cutting, or the like once the surfaces have cooled. When the first layer 12 and the second layer 60 are affixed together to form the modular mat system 10, the guides holes 39 of the second band 36 and the first band 44 of the first layer and the second layer can line up with the corresponding guide holes of the opposing layers, as illustrated in FIG. 9. The guides holes 39 can have a channel on the exterior surface 28 and the second band 36 of the first layer 12 and the second layer 60 wherein the guide holes can extend to the interior surface 18 as a solid material.

As shown in FIG. 9 the second layer 60 can have all the features of the first layer 12. Referring to FIG. 8 - 10, the modular mat system 10 when attached to another mat modular system, or a plurality of modular mat by adjoining, overlapping and interlocking the modular mat by a plurality of pins 70. The modular mat system 10 can be extendable in multiple directions to accommodate the topographic area it will be placed on. The topographic area that the modular mat system 10 is directed at conforming to can be adapted to different topographic or geographic features of the surface of the ground such as grass, dirt, rocks, or the like, wherein when the modular mat system are connected together the vehicle’s weight can be distributed equally over a larger surface area and can operate as one complete mat wherein the pin 70 can connect the modular mats systems together creating a larger modular mat system 100 with multiple mats, which allows the user to create a customized ground cover for heavy industrial equipment to drive over, or be placed on.

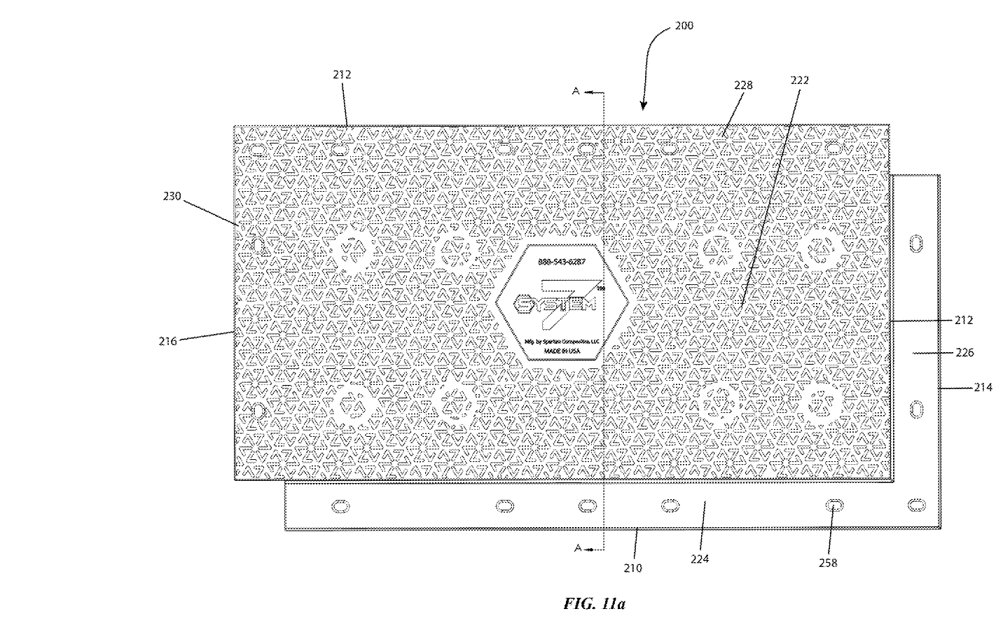

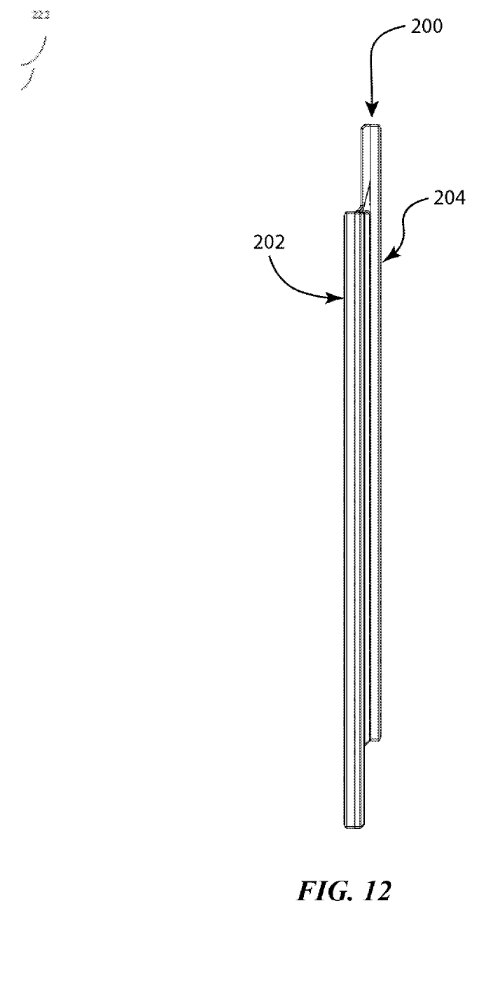

Referring now to FIGS. 10 through 14, a second embodiment of a modular mat system is shown generally at 200. The modular mat system 200 comprises a mat panel 202 and an overlay portion 204. The mat panel 202 has a top skin 206, a bottom skin 208, a first side 210, a second side 212, a first end 214, a second end 216, and a base portion 218. The base portion 218 has a top surface 206 and a first thickness 219. The first thickness 219 can be between 0.25 inches and 12 inches, more preferably between 0.5 inches and 6 inches, and still more preferably approximately 5 inches. The overlay portion 204 has a second thickness 220 and with the base portion forms a central core section 222 that extends from the top surface 206 of the base portion 218.

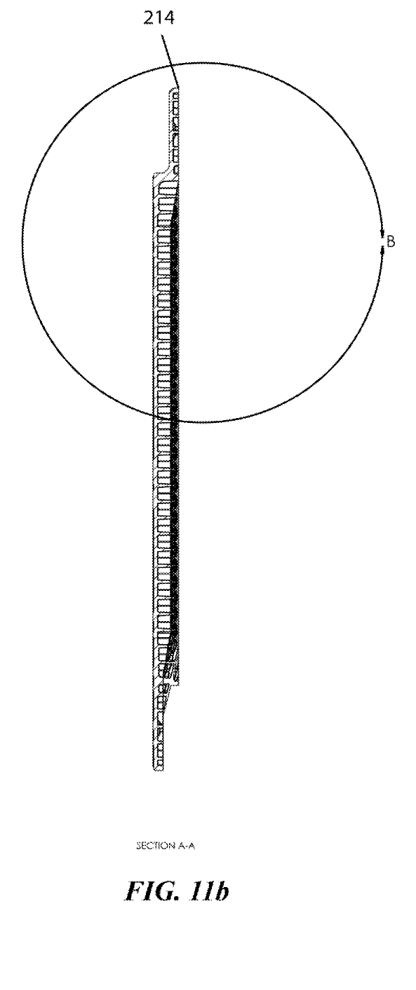

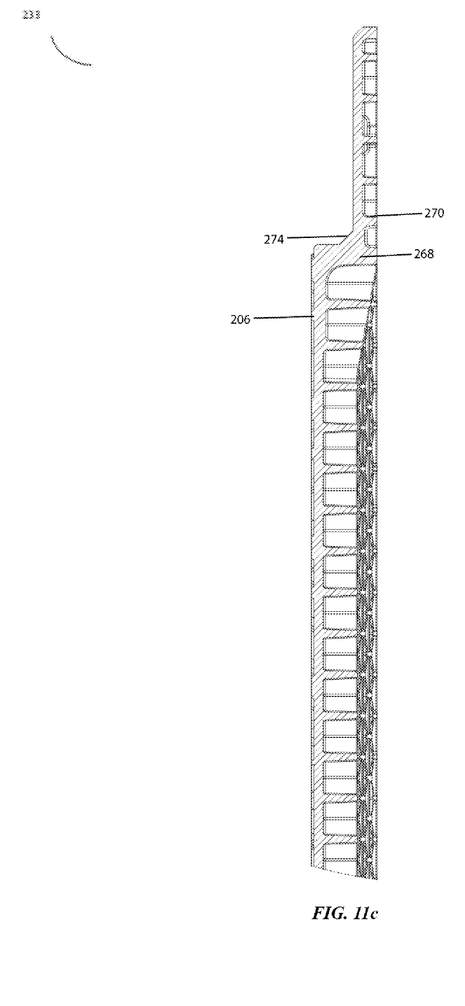

The base portion 218 extends past the overlay portion 204 on the first side 210 to form a base side extension portion 224, and extends past the overlay portion on the first end 214 to form a base end extension portion 226. The overlay portion 204 extends past the base portion 218 on the second side 212 to form an overlay side extension portion 228, and extends past the base portion on the second end 216 to form an overlay end extension portion 230. The base side extension portion 224, base end extension portion 226, overlay side extension portion 228, and overlay end extension portion 230 collectively form a flange 231 surrounding the central core section 222. The flange 231 has a top surface 233, a bottom surface 235, and a flange thickness 237. The base side extension portion 224 is configured to fit beneath the overlay side extension portion 228 of a first adjacent mat panel 201, and the base end extension portion 226 is configured to fit beneath the overlay end extension portion 230 of a second adjacent mat panel 203, as shown in FIGS. 10 and 11a. This configuration allows for the seamless integration of multiple mat panels into a larger unified surface.

The central core section 222 has a first interior cellular structure 232. The cells of the first interior cellular structure 232 have a first cross section defining a first open area 236 and a first ribbed area 238, establishing a first ratio of ribbed area to open area. In a preferred embodiment the cells of the first interior cellular structure 232 are hexagonal. Finite element analyses demonstrate that hexagonal cell diameters between 1.57 inches and 3.00 inches, without longitudinal stringers, achieve compressive stiffness values between approximately 660,000 lb/in and 961,000 lb/in under a 42,667-pound load applied to an 8-inch by 8-inch area while maintaining maximum von Mises stress below the 2,700 psi yield threshold of the mat material. Cell diameters between 1.57 inches and 2.75 inches represent a preferred range for stringer-free configurations. Where at least one longitudinal stringer 239 extends across the first interior cellular structure 232 parallel to the first side 210 or the second side 212, cell diameters between 2.57 inches and 5.00 inches can achieve compressive stiffness values of at least 850,000 lb/in while maintaining von Mises stress below 2,700 psi, with a combined stiffness rating — defined as the sum of the relative bending stiffness value and the relative compressive stiffness value each normalized to a stringer-core geometry at 2.57-inch cell diameter — of at least 1.77.

The central core section 222 has a first reinforced area 276 on the first side 210 and the second side 212. The first reinforced area 276 has a second cellular structure 240 formed from ribs, wherein the cells of the second cellular structure 240 have a second cross section 242 defining a second open area 244 and a second ribbed area 246, establishing a second ratio of ribbed area to open area. The second ratio is greater than the first ratio. The reinforced area may be formed by forming longitudinal stringers in the cell pattern in the reinforced area.

The central core section 222 further has a second reinforced area 278 on the first end 214 and the second end 216. The second reinforced area 278 has a third interior cellular structure 250 formed from ribs, wherein the cells of the third cellular structure 250 have a third cross section 252 defining a third open area 254 and a third ribbed area 256, establishing a third ratio of ribbed area to open area. The third ratio is greater than the second ratio. The progressively increasing rib density from the central region of the mat panel outward toward the first wall rib 268 provides increasing structural support in the regions of highest stress concentration, while maintaining the central core section at a cell density optimized for the combined compressive and bending stiffness performance described above.

The first wall rib 268, shown in detail in FIG. 11c, is the largest structural rib in the mat panel 202. The first wall rib 268 has a cross-sectional thickness greater than the rib thickness of the first interior cellular structure 232, the second cellular structure 240, and the third cellular structure 250. The first wall rib 268 has an interior surface 269 that substantially surrounds and defines the perimeter of the central core section 222, and an exterior surface 271 that faces the flange 231. The first wall rib 268 is configured to reinforce the central core section 222 against deflection loading. In particular, the first wall rib 268 elevates the local yield threshold of the mat panel body such that under design compressive and bending loads, the maximum von Mises stress in the mat panel first reaches the yield stress of the mat material at a location outboard of the first wall rib 268 — that is, within the flange 231 — rather than within the central core section 222. This controlled failure sequence directs fracture initiation to the flange, which is a less severe and more readily repaired failure mode than fracture through the mat body, addressing the persistent field failure mode reported by customers of prior art mat systems.

A sloped transition surface 274 connects the exterior surface 271 of the first wall rib 268 to the top surface 233 of the flange 231, as shown in FIGS. 11b and 11c. The sloped transition surface 274 is oriented at an oblique angle between 10 degrees and 80 degrees relative to the top surface 233 of the flange 231. The sloped transition surface 274 distributes stress across a broader region and enables the fusion weld to extend continuously from the central core section 222, across the sloped transition surface 274, and into the flange 231 without interruption.

The base portion 218 and the overlay portion 204 may be fusion welded together. In a preferred embodiment, as shown in FIGS. 10 through 12, the fusion weld extends continuously across all transitions in the mat panel 202. No unwelded interface exists at the first wall rib 268. The cell ribs 266 of the base portion 218 are welded to the cell ribs of the overlay portion 204 across the entirety of the interior surface. The top surface 233 of the flange 231 may be oriented at zero degrees relative to the horizontal plane of the mat panel 202. The fusion weld between the base portion 218 and the overlay portion 204 at the flange 231 may be formed on this zero-degree top surface 233.

A rib 270 may be disposed on the flange 231 outboard of the first wall rib 268, as shown in FIG. 11c. The second wall rib 270 extends between the top surface 233 and the bottom surface 235 of the flange 231 and runs along the full length of the intersection of the flange 231 with the first wall rib 268. The second wall rib 270 cooperates with the first wall rib 268 and the sloped transition surface 274 to distribute applied stress away from the first wall rib 268 and into the body of the flange 231, reducing the peak stress concentration at the first wall rib and further enforcing the preferred failure sequence. A reinforcement row 272 may be provided on the flange between the first wall rib 268 and the second wall rib 270 to provide additional structural support in this region.

The flange 231 may have a locally increased skin thickness in the region of the second wall rib 270. In a preferred embodiment the skin thickness of the flange 231 in the region of the second wall rib 270 is at least 0.638 inches, compared to a nominal flange skin thickness of 0.500 inches — an increase of approximately 27.6%. This locally increased skin thickness cooperates with the second wall rib 270 to stiffen the flange in the region outboard of the first wall rib 268, distributing bending stress into the flange rather than concentrating it at the first wall rib. Having similar masses on both the base side extension portion 224, base end extension portion 226, overlay side extension portion 228, and overlay end extension portion 230 helps eliminate warpage when the mat panels are connected.

Each of the base side extension portion 224, base end extension portion 226, overlay side extension portion 228, and overlay end extension portion 230 may include at least one guide hole 258. The guide holes 258 facilitate alignment and connection of multiple mat panels using connecting pins, as described above with respect to the first embodiment. The top skin 206 of the central core section 222, the overlay side extension portion 228, and the overlay end extension portion 230 each have a coplanar exterior surface 260 comprising a plurality of traction elements 262 raised from the exterior top surface 264, providing increased grip and stability for vehicles and personnel on the mat surface.

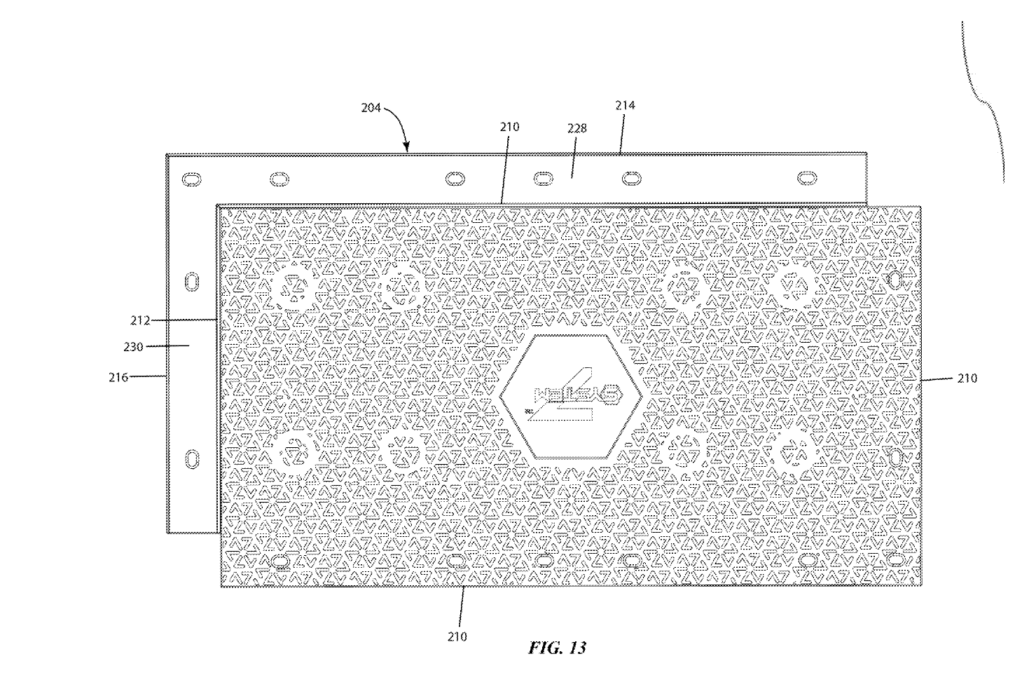

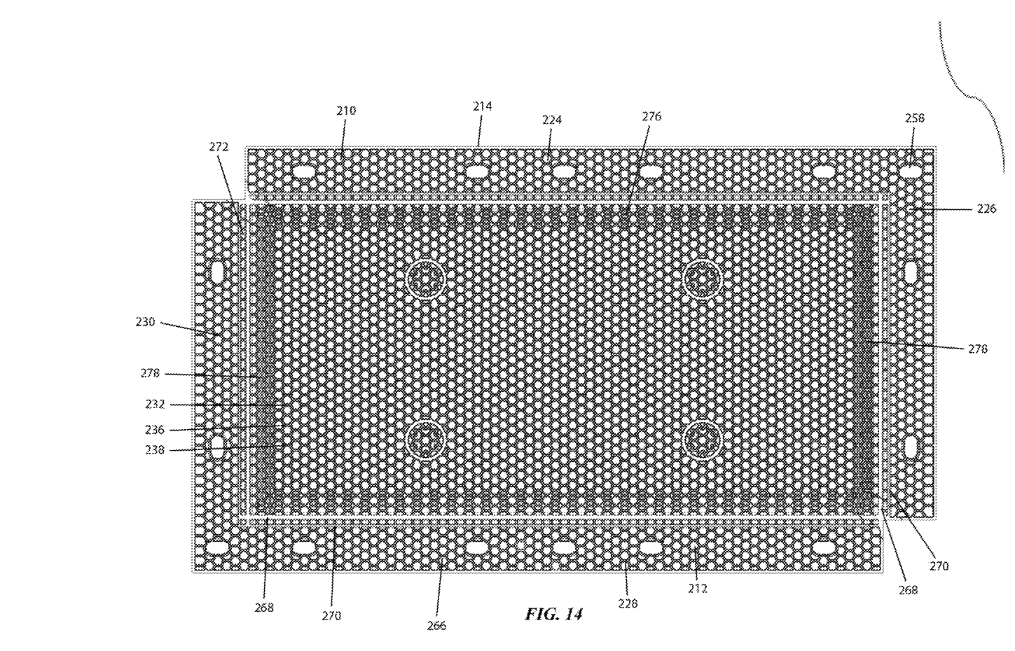

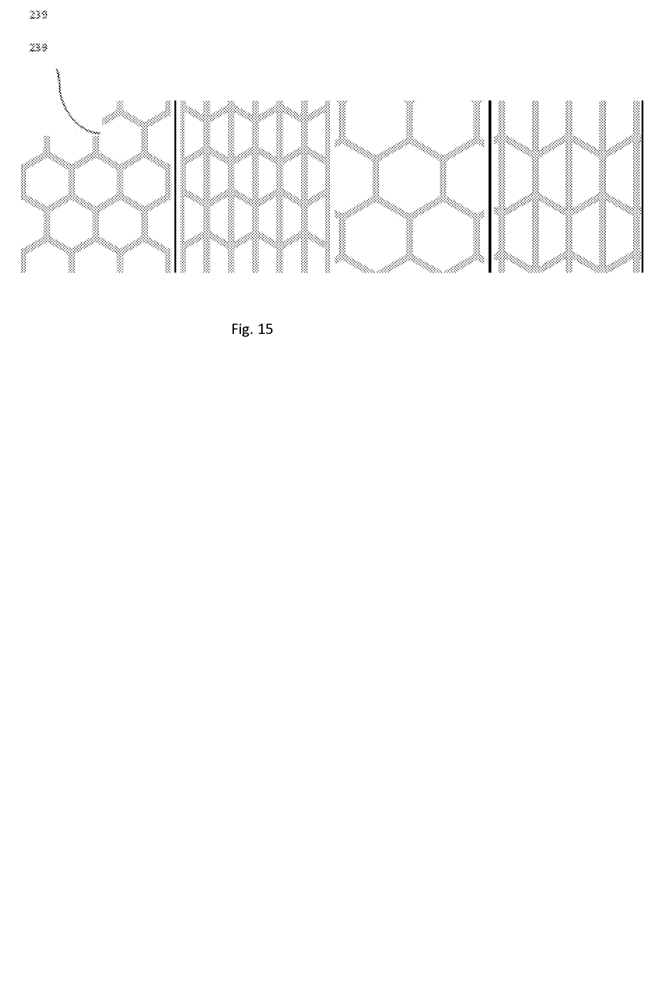

As shown in FIGS. 13 and 14, the bottom skin 208 of the mat panel 202 comprises a plurality of vacuum-sealable pad regions 280. The vacuum-sealable pad regions 280 are dimensioned and configured to form an airtight seal with vacuum lifting cups of a robotic handling system, enabling the mat panel 202 to be lifted, positioned, and lowered by robotic equipment without manual handling. The vacuum-sealable pad regions 280 are distributed across the bottom skin 208 in a pattern configured to enable balanced robotic lifting of the mat panel 202. In a preferred embodiment the vacuum-sealable pad regions 280 are substantially flat and are recessed from or flush with the exterior bottom surface to promote consistent vacuum cup contact and sealing.

The modular mat system 200 may be constructed of any suitable material having the strength and durability requirements necessary for heavy industrial use, including but not limited to high-density polyethylene (HDPE), polystyrene, polypropylene, acrylonitrile butadiene styrene, or polyvinylchloride. In a preferred embodiment the material is HDPE, which is capable of bending, flexing, compressing, and resisting impacts without cracking or breaking, and is resistant to a wide range of temperatures and ultraviolet radiation.

The base portion 218 and the overlay portion 204 can be joined together to form one complete module mat system 200 by affixing the interior surfaces together, including, but not limited to, fusion welding, hot welding or hand welding, seam welding and other methods appropriate for the materials comprising the base portion and the overlay portion. Further, multiple methods of affixing the base portion 218 and the overlay portion 204 together can be utilized simultaneously such as, for example, the inner portions can be fusion welded and can be seamed welded together creating a seal around the modular mat system. The base portion 218 and the overlay portion 204 can be welded together wherein at least a portion of the cellular structures can be welded, but more preferably the entire inner portion of the cellular structures are welded together such that the base portion 218 and the overlay portion 204 can become one piece.

During the welding process the base portion 218 and the overlay portion 204 can be heated to a temperature sufficient to soften, but not melt, the material and the first layer and the second layer can be compressed together having each side overlap by for example, between .032 and 4 inches, more preferably between .1 inches and 2 inches and still more preferably a vertical offset of at least .125 inch. The base portion 218 and the overlay portion 204 can overlap by for example, between .032 and 4 inches, more preferably between .1 inches and 2 inches and still more preferably a vertical offset of at least .25 inch when compressed together. Any material extruded at the seam of the joined surfaces resulting from compression may be removed, such as by grinding, milling, routing, cutting, or the like once the surfaces have cooled. When the base portion 218 and the overlay portion 204 are affixed together to form the modular mat system 200.

It is to be understood that although aspects of the present specification are highlighted by referring to specific embodiments, one skilled in the art will readily appreciate that the disclosed embodiments are only illustrative of the principles of the subject matter disclosed herein. The disclosed subject matter is in no way limited to a particular methodology, protocol, or configuration described herein. Various modifications or changes to or alternative configurations of the disclosed subject matter can be made in accordance with the teachings herein without departing from the spirit of the present specification. The terminology used herein is for the purpose of describing particular embodiments only and is not intended to limit the scope of the present disclosure, which is defined solely by the claims. Accordingly, embodiments of the present disclosure are not limited to those precisely as shown and described.

Certain embodiments are described herein, including the best mode known to the inventors for carrying out the invention. Variations on these described embodiments will become apparent to those of ordinary skill in the art upon reading the foregoing description. This disclosure includes all modifications and equivalents of the subject matter recited in the claims appended hereto as permitted by applicable law. Moreover, any combination of the above-described embodiments in all possible variations thereof is encompassed by the disclosure unless otherwise indicated herein or otherwise clearly contradicted by context.

We claim:

1. A modular mat system comprising: a plurality of mat panels, each mat panel comprising a top skin, a bottom skin, a first side, a second side, a first end, and a second end; a panel core section; and a flange about the periphery of the panel core section, the flange having a top surface, a bottom surface and a flange thickness; wherein the panel core section and the flange comprise: a base portion having a base core section having a base interior cell structure formed from base ribs having a base core rib thickness, a base side extension on the first side and a base end extension on the second side; an overlay portion having an overlay core section having an overlay interior cell structure formed from overlay ribs having an overlay core rib thickness, an overlay side extension that extends from the second side and an overlay end extension that extends from the second end; wherein the base side extension is configured to fit beneath the overlay side extension of a first adjacent mat panel and the base end extension is configured to fit beneath the overlay end extension of a second adjacent mat panel;wherein the base side extension, base end extension, overlay side extension, and overlay end extension collectively form the flange;a first wall rib having a cross-sectional thickness greater than the core section rib thickness, the first wall rib having an interior surface that substantially surrounds and defines the perimeter of the panel core section and an exterior surface that faces the flange, the first wall rib being configured to reinforce the central core section against deflection loading; anda sloped transition surface connecting the exterior surface of the first wall rib to the top surface of the flange.

2. The modular mat system of claim 1, wherein the base core rib thickness is the same as the overlay core rib thickness.

3. The modular mat system of claim 2, wherein the base portion and the overlay portion are fusion welded together.

4. The modular mat system of claim 3 wherein the overlay ribs are welded to the base ribs.

5. The modular mat system of claim 1, wherein the flange is welded to the first wall at zero degrees relative to the horizontal plane of the first wall.

6. The modular mat system of claim 1, further comprising a second wall rib disposed on the flange outboard of the first wall rib, the second wall rib extending between the top surface and the bottom surface of the flange and running along the full length of the intersection of the flange with the first wall rib.

7. The modular mat system of claim 6, wherein the flange has skin thickness and a locally increased skin thickness in the region of the second wall rib relative to the nominal skin thickness of the flange.

8. The modular mat system of claim 7, wherein the locally increased skin thickness is at least 0.638 inches where the nominal skin thickness of the flange is 0.500 inches.

9. The modular mat system of claim 6, further comprising a reinforcement row disposed between the first wall rib and the second wall rib on the flange.

10. The modular mat system of claim 1, wherein the sloped transition surface is oriented at an oblique angle between 10 degrees and 80 degrees relative to the top surface of the flange.

11. The modular mat system of claim 1, wherein the sloped transition surface is integrally formed with the panel core section and the flange.

12. The modular mat system of claim 1, wherein the first wall rib and the continuous fusion weld are configured such that under a design compressive load the maximum von Mises stress in the mat panel first reaches the yield stress of the mat material at a location outboard of the first wall rib, whereby the flange fails before the central core section.

13. The modular mat system of claim 1, wherein the panel core section has a first interior cellular structure defined by ribs forming cells having a first cross section that defines a first open area and a first ribbed area establishing a first ratio of ribbed area to open area, and wherein the panel core section has at least one reinforced area adjacent the first side or the second side having a second cellular structure with a second ratio of ribbed area to open area greater than the first ratio.

14. The modular mat system of claim 13, wherein the central core section has a second reinforced area on the first end and the second end having a third cellular structure with a third ratio of ribbed area to open area greater than the second ratio.

15. The modular mat system of claim 13, wherein the cells of the first interior cellular structure are hexagonal and have a cell diameter between 1.57 inches and 3.00 inches.

16. The modular mat system of claim 15, wherein the cell diameter is between 1.57 inches and 2.75 inches.

17. The modular mat system of claim 13, wherein the central core section further comprises at least one longitudinal stringer extending across the first interior cellular structure parallel to the first side or the second side, and wherein the cells of the first interior cellular structure have a diameter between 2.57 inches and 5.00 inches.

18. The modular mat system of claim 1, wherein the flange includes at least one guide hole configured to receive a connecting pin to join adjacent mat panels.

19. The modular mat system of claim 1, wherein the panel core section has a top skin and the top skin having a plurality of traction elements raised from the exterior top surface.

20. The modular mat system of claim 1, wherein the panel core section has a bottom skin and the bottom skin comprises at least one of vacuum-sealable pad region configured to form an airtight seal with vacuum lifting cups of a robotic handling system.

21. The modular mat system of claim 20, wherein the vacuum-sealable pad regions are distributed across the bottom skin in a pattern configured to enable balanced robotic lifting of the mat panel.

22. The modular mat system of claim 1, wherein the mat panel is constructed from high-density polyethylene.

23. A method of assembling a modular mat for heavy industrial equipment, the method comprising the acts of: providing a base portion having a base core section surrounded by a base wall rib having a base wall rib exterior surface; connecting a base side extension to the base wall rib exterior surface on a first side and a base end extension to the base wall rib exterior surface on a first end such that a sloped transition surface connects the base wall rib exterior surface to the base side extension and the base end extension; providing an overlay portion having an overlay core section surrounded by an overlay wall rib having an overlay wall rib exterior surface; connecting an overlay side extension to the overlay wall rib exterior surface on a second side and an overlay end extension to the overlay wall rib exterior surface on a second end such that a sloped transition surface connects the overlay wall rib exterior surface to the overlay side extension and the overlay end extension; welding the base portion to the overlay portion.

24. The method of claim 23, further comprising lifting at least one mat panel using a robotic handling system having vacuum lifting cups applied to vacuum-sealable pad regions on the bottom skin of the mat panel.

25. The method of claim 23, wherein welding the base portion to the overlay portion creates a panel wall rib having a panel wall rib exterior surface and wherein the base side extension and the base end extension are connected to the base wall rib and the overlay side extension and the overlay end extension are connected to overlay wall rib such that there is no unwelded interface at the panel wall rib exterior surface.

26. The method of claim 23 wherein connecting the base side extension to the base wall rib exterior surface on the first side and the base end extension to the base wall rib exterior surface on the first end and connecting the overlay side extension to the overlay wall rib exterior surface on the second side and the overlay end extension to the overlay wall rib exterior surface on the second end is done by forming at least one pourable mold and forming the base portion and the overlay portion by inserting liquid material into the at least one pourable mold and allowing the liquid material to cool.

27. The method of claim 23 wherein the base portion is identical to the overlay portion.

28. The method of claim 26 wherein the base portion is identical to the overlay portion and the at least one pourable mold is one pourable mold.

29. The method of claim 23 wherein the base side extension is fusion welded to the base wall rib exterior surface on the first side, the base end extension is fusion welded to the base wall rib exterior surface on the first end, the overlay side extension is fusion welded to the overlay wall rib exterior surface on the second side and the overlay end extension is fusion welded to the overlay wall rib exterior surface on the second end.

30. The method of claim 29 wherein the sloped transition is formed during fusion welding.
